(19) United States
(12) Patent Application Publication
(10) Pub. No.: US 2009/0234819 A1
(43) Pub. Date: Sep. 17, 2009

(54) METADATA ASSIGNING DEVICE, METADATA ASSIGNING METHOD, AND METADATA ASSIGNING PROGRAM

(76) Inventor: Kentaro MIYAMOTO, Tokyo (JP)

Correspondence Address: BIRCH STEWART KOLASCH & BIRCH, PO BOX 747, FALLS CHURCH, VA, 22040-0747, US

(21) Appl. No.: 12/402,163

(22) Filed: Mar. 11, 2009

(30) Foreign Application Priority Data
Mar. 12, 2008 (JP) 2008-063283

(51) Int. Cl. G06F 17/30

(52) U.S. Cl. 707/3; 707/E17.022

(57) ABSTRACT

Text data is input with an image to a server. At least one area which belongs to any one of predetermined categories is extracted from the image. Plural keywords belonging to the corresponding category are extracted from the text data. One feature quantity is obtained for the extracted area. A list table of feature quantity in which image feature quantities and keywords in the category are related to each other one by one is referred, and plural of the image feature quantities are retrieved based on the extracted plural keywords. One image feature quantity most similar to the obtained feature quantity is selected from among the plural image feature quantities. The list table of feature quantity is referred, and the keyword related to the selected image feature quantity is obtained. The obtained keyword is selected as metadata.

### FIELD OF THE INVENTION

The present invention relates to a metadata assigning device, a metadata assigning method, and a metadata assigning program for assigning metadata to an image.

### BACKGROUND OF THE INVENTION

It has recently been possible to obtain a large number of images with ease through the spread of information terminal devices such as mobile phones and personal computers. Along with this trend, now images can be freely registered and searched by the general public and the idea of sharing information among any users is created (so-called Web 2.0). For example, photo sharing services such as “Flickr” (trademark) and free encyclopedias such as “Hatena Bookmark” and “Wikipedia” are already in practical use.

In the above-described systems for registering and searching images, words (tags or additional information) characterizing the image are assigned to each image as metadata so that users can effectively search a desired image from among a huge number of images. Such system is called folksonomy.

When searching a desired image from among a huge number of images based on metadata, search results will depend on metadata quality which is to whether appropriate and sufficient metadata are assigned to each image. To enhance the metadata quality, a recognition gap toward each image between the user who registers the image and the user who searches the image needs to be closed. In addition, the user who registers the image is required to have large vocabularies and flexible ideas. In view of this, various techniques for assigning metadata are proposed (for example, Japanese Patent Application Laid-open Publications No. 2003-228569, 10-326278 and 2004-234228).

According to the invention disclosed in Japanese Patent Application Laid-open Publication No. 2003-228569, keywords are extracted from text data which explains an image, and among the keywords, those having high degree of relevance with the image are selected and assigned to the image as metadata.

According to the invention disclosed in Japanese Patent Application Laid-open Publication No. 10-326278, a database in which feature quantity of an image and keywords are registered in association with each other is referred, and the keywords corresponding to the feature quantity extracted from the image are retrieved from the database. The retrieved keywords are assigned to the image as metadata.

According to the invention disclosed in Japanese Patent Application Laid-open Publication No. 2004-234228, feature quantity is extracted from an image, and a similar image is retrieved from a database based on the extracted feature quantity. Keywords given to the retrieved image is assigned to the image as metadata.

In the invention disclosed in Japanese Patent Application Laid-open Publication No. 2003-228569, however, selection of important keywords becomes difficult and the selection process takes time as the number of the extracted keywords increases.

In the inventions disclosed in Japanese Patent Application Laid-open Publications No. 10-326278 and 2004-234228, high quality metadata can be assigned to the image when a large amount of data is registered in the database. However, searching process of the keywords to be selected as metadata takes time as the volume of the data increases.

### SUMMARY OF THE INVENTION

An object of the present invention is to provide a metadata assigning device, a metadata assigning method and a metadata assigning program capable of shortening processing time for selecting a keyword.

In order to achieve the above and other objects, a metadata assigning device of the present invention includes an area extractor, a keyword extractor, a feature quantity obtaining section and a keyword selecting section. The area extractor extracts at least one area belonging to a predetermined category from the image. The keyword extractor extracts plural keywords belonging to the category from the text data. The feature quantity obtaining section obtains one feature quantity for the extracted area. The keyword selecting section refers to a list table of feature quantity in which image feature quantities and keywords in the category are related to each other one by one and retrieves plural of the image feature quantities based on the extracted plural keywords. The keyword selecting section then selects one of the retrieved image feature quantities which is most similar to the obtained feature quantity. Moreover, the keyword selecting section obtains the keyword related to the selected image feature quantity on the list table of feature quantity and selects the obtained keyword as metadata.

A metadata assigning method and a metadata assigning program of the present invention include an area extracting step, a keyword extracting step, a feature quantity obtaining step, an image feature quantity retrieving step, an image feature quantity selecting step, and a metadata selecting step. In the area extracting step, at least one area belonging to a predetermined category is extracted from the image. In the keyword extracting step, plural keywords belonging to the category are extracted from the text data. In the feature quantity obtaining step, one feature quantity is obtained for the extracted area. In the image feature quantity retrieving step, a list table of feature quantity in which image feature quantities and keywords in the category are related to each other one by one is referred, and plural of the image feature quantities are retrieved based on the extracted plural keywords. In the image feature quantity selecting step, one of the retrieved image feature quantities which is most similar to the obtained feature quantity is selected. In the metadata selecting step, the keyword related to the selected image feature quantity is obtained on the list table of feature quantity, and the obtained keyword is selected as metadata.

In a preferable embodiment of the present invention, the area is a human face area and the keywords are names of persons.

According to the metadata assigning device, the metadata assigning method, and the metadata assigning program of the present invention, the number of the data referred in selecting the keyword is limited. Owing to this, the processing time required for selecting the keyword can be shortened.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a schematic diagram illustrating a configuration of a network system;

FIG. 2 is a block diagram illustrating a configuration of a client terminal;

FIG. 3 is a block diagram illustrating a configuration of a server;

FIG. 4 is an explanatory view illustrating an example of a list table of person name;

FIG. 5 is an explanatory view illustrating an example of a list table of car name;

FIG. 6 is an explanatory view illustrating an example of a list table of citrus fruit name;

FIG. 7 is an explanatory view illustrating an example of a list table of feature quantity;

FIG. 8 is an explanatory view illustrating extraction of areas;

FIG. 9 is an explanatory view illustrating judgment of similarities of feature quantities; and

FIG. 10 is a flow chart explaining processing procedures for assigning metadata.

### DESCRIPTION OF THE PREFERRED EMBODIMENTS

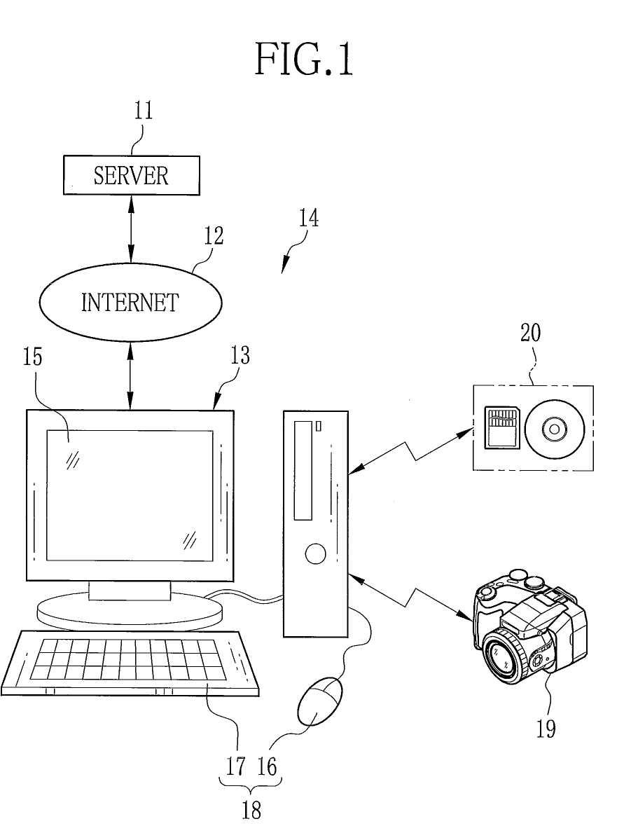

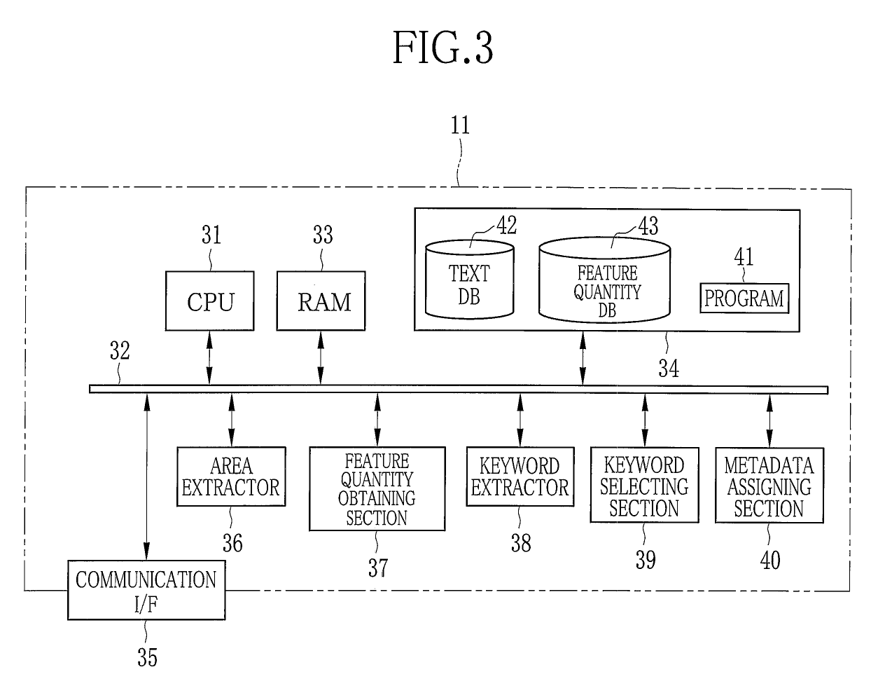

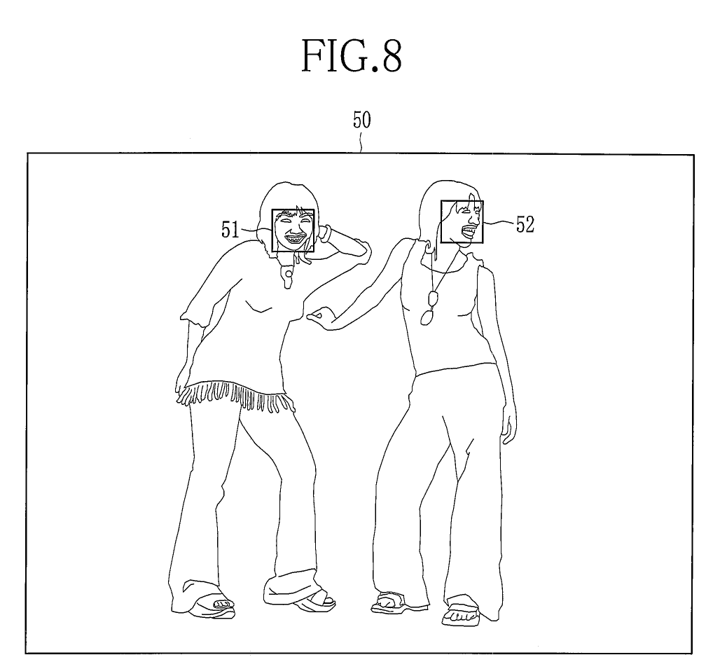

In FIG. 1, a metadata assigning device is configured by installing a metadata assigning program 41 on a server 11 (see FIG. 3). The metadata assigning device selects a keyword from text data, which is input with an image, based on feature quantity of the image, and assigns the selected keyword to the image as metadata. In this embodiment, the case where text data “Popular idols Kayla and Alyssa release their first collaboration photo book. Shooting is well under way by the photographer Michael.” is input with an image 50 (see FIG. 8) is explained as an example.

The server 11 and a client terminal 13 connected to the server 11 through an internet 12 form a network system 14. The client terminal 13 is, for example, the well-known personal computer or work station, and has a monitor 15 for displaying various operation screens and an operation section 18 including a mouse 16 and a keyboard 17. The operation section 18 is operated to input text data to the server 11 and outputs operation signals.

Images shot with a digital camera 19 or recorded in a recording medium 20 like a memory card and a CD-ROM are sent to the client terminal 13. Images may also be sent to the client terminal 13 through the internet 12.

The digital camera 19 is connected to the client terminal 13 via a wireless LAN or a communication cable complying with, for example, IEEE 1394 or Universal Serial Bus (USB), and thereby communicating data with the client terminal 13. The recording medium 20 is also capable of communicating data with the client terminal 13 via a specific driver.

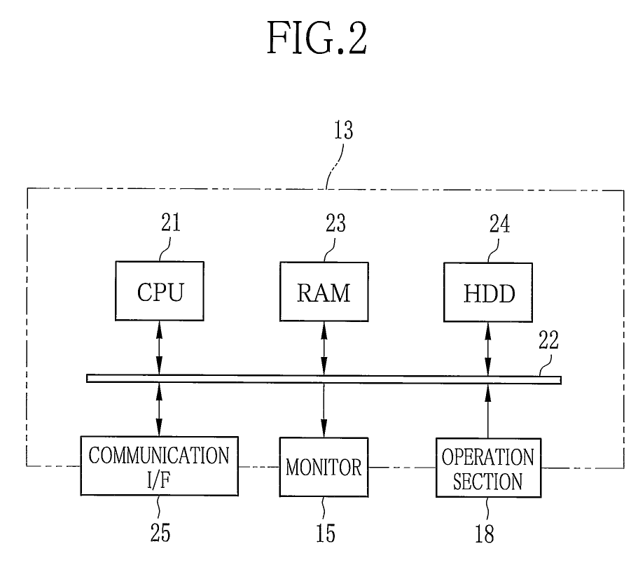

As shown in FIG. 2, the client terminal 13 has a CPU 21, and the CPU 21 takes overall control of the client terminal 13 according to, for example, the operation signals input from the operation section 18. In addition to the operation section 18, a RAM 23, a HDD 24, a communication I/F 25 and the monitor 15 are connected to the CPU 21 via a data bus 22.

The RAM 23 is a work memory used for the CPU 21 to execute processing. The HDD 24 stores various programs and data for operating the client terminal 13. The HDD 24 also stores image data loaded from the digital camera 19 and the recording medium 20, and through the internet 12. The CPU 21 reads out the programs from the HDD 24 and deploys them in the RAM 23. The CPU 21 then sequentially executes the loaded programs.

The communication I/F 25 is, for example, a modem or a router that controls communication protocol suitable for the internet 12, and communicates data via the internet 12. The communication I/F 25 also mediates the data communication of the client terminal 13 with external devices like the digital camera 19 and the recording medium 20.

As shown in FIG. 3, the server 11 has a CPU 31, and the CPU 31 takes overall control of the server 11 according to, for example, the operation signals input from the client terminal 13 via the internet 12. A RAM 33, a HDD 34, a communication I/F 35, an area extractor 36, a feature quantity obtaining section 37, a keyword extractor 38, a keyword selecting section 39 and a metadata assigning section 40 are connected to the CPU 31 via a data bus 32.

The RAM 33 is a work memory used for the CPU 31 to execute processing. The HDD 34 stores various programs and data for operating the server 11. The HDD 34 also stores the metadata assigning program 41. The CPU 31 reads out the programs from the HDD 34 and deploys them in the RAM 33. The CPU 31 then sequentially executes the loaded programs.

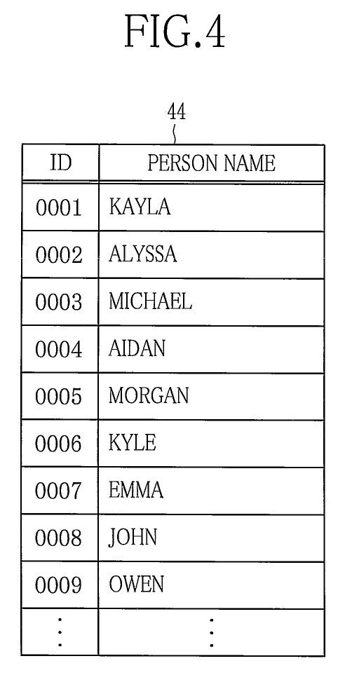

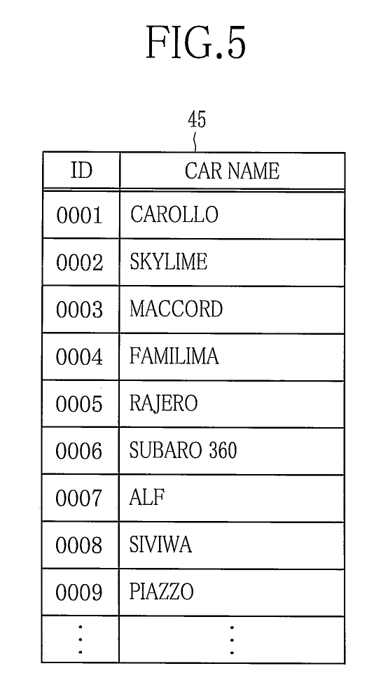

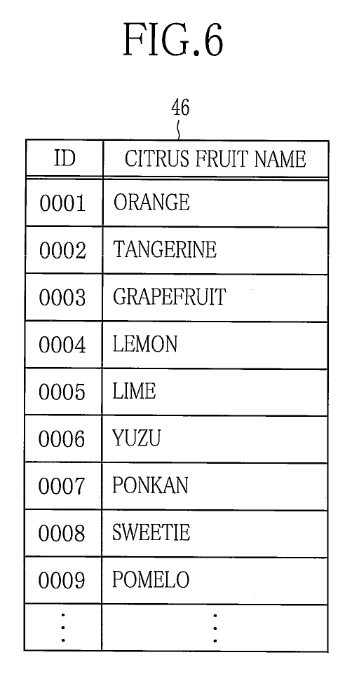

In the HDD 34, there provided a text database (DB) 42 and a feature quantity database (DB) 43. The text DB 42 stores list tables of word related to various categories, such as a list table 44 of person name related to a category “human” as shown in FIG. 4, a list table 45 of car name related to a category “car” as shown in FIG. 5 and a list table 46 of citrus fruit name related to a category “citrus fruit” as shown in FIG. 6. Other categories may be flower, cosmetic, and the like.

In the list table 44 of person name shown in FIG. 4, names of persons like “Kayla”, “Alyssa”, “Michael”, “Aidan”, “Morgan”, “Kyle”, “Emma”, “John”, “Owen” and the like are stored with a word ID (serial number) automatically given to each name at the time of the registration as an index.

In the list table 45 of car name shown in FIG. 5, names of cars like “Carollo”, “Skylime”, “Maccord”, “Familima”, “Rajero”, “Subaro 360”, “Alf”, “Siviwa”, “Piazzo” and the like are stored with a word ID (serial number) automatically given to each name at the time of the registration as an index.

In the list table 46 of citrus fruit name shown in FIG. 6, names of citrus fruits like “Orange”, “Tangerine”, “Grapefruit”, “Lemon”, “Lime”, “Yuzu”, “Ponkan”, “Sweetie”, “Pomelo” and the like are stored with a word ID (serial number) automatically given to each name at the time of the registration as an index.

Similarly to the list tables 44, 45 and 46, list tables of word related to other categories are also stored with serial numbers given at the time of registration as word IDs. The words may be, for example, parts of speech like adjectives or adverbs, sentences like “The world can be changed one by one.”, or in any other forms. The word IDs of each list table are given for the sake of management purpose only, and the word IDs do not depend on each other. Note that all the list tables of word may be merged into one as long as the words are managed on a category to category basis. It is also possible that the same word is stored in plural list tables.

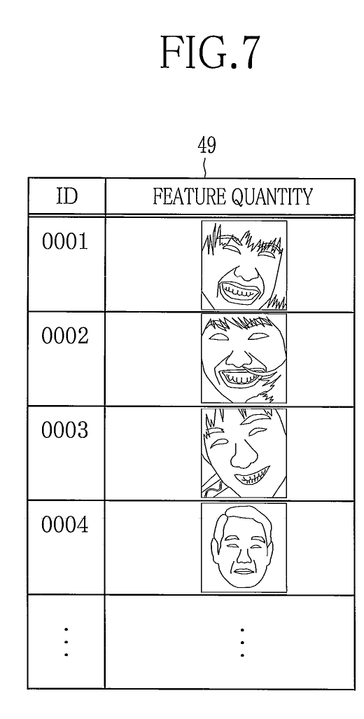

The feature quantity DB 43 stores list tables of feature quantity of various categories, such as a list table 49 of human feature quantity as shown in FIG. 7, a list table of car feature quantity (not shown), a list table of citrus fruit feature quantity (not shown). The list tables of feature quantity stored in the feature quantity DB 43 respectively correspond to the list tables of word stored in the text DB 42 one by one. Note that all the list tables of feature quantity may be merged into one as long as the feature quantities are managed on a category to category basis. It is also possible that the text DB 42 and the feature quantity DB 43 are merged into one database as long as the word list tables and the feature quantity list tables are managed to correspond with each other one by one.

In the list table 49 of human feature quantity shown in FIG. 7, an image feature quantity related to “Kayla”, an image feature quantity related “Alyssa”, an image feature quantity related “Michael”, an image feature quantity related “Aidan” and the like are each stored with the word ID of the table list 44 of person name (see FIG. 4) as an index. Although the image feature quantities are depicted as illustrations in FIG. 7 for the sake of convenience, the image feature quantities are actually numeric data.

Similarly, in the list table of car feature quantity, an image feature quantity related to “Carollo”, an image feature quantity related to “Skylime”, an image feature quantity related to “Maccord” and the like are each stored with the word ID of the table list 45 of car name (see FIG. 5) as an index. In the list table of citrus fruit feature quantity, an image feature quantity related to “Orange”, an image feature quantity related to “Tangerine”, an image feature quantity related to “Grapefruit” and the like are each stored with the word ID of the table list 46 of citrus fruit name (see FIG. 6) as an index. Similarly to the list tables of these feature quantities, list tables of feature quantities of other categories also store image feature quantities with the word IDs of corresponding table list of words as the index. Note that all the list tables may be merged into one as long as the image feature quantities are managed on a category to category basis.

Referring back to FIG. 3, the communication I/F 35 is, for example, a modem or a router that controls communication protocol suitable for the internet 12, and communicates data via the internet 12. The communication I/F 35 also works as an input section to which text data are input with images. The images and the text data input through the communication I/F 35 are temporarily stored in the RAM 33.

The area extractor 36 analyzes the image that is input to the server 11. The area extractor 36 then extracts, from the image, at least one area including any one of the categories of the feature quantity list tables stored in the feature quantity DB 43 and also judges the category to which the extracted area belongs. For example, face areas 51 and 52 are extracted from the image 50 shown in FIG. 8, and the extracted face areas 51 and 52 are judged as belonging to the category of “human”. To extract the area, the method for extracting an outline of a form and digitizing the extracted outline by Fourier transformation, the method based on periodicity and direction of a basic pattern, the method based on hue, brightness and saturation, and the like disclosed in, for example, Japanese Patent Application Laid-open Publications No 10-326278 and 2004-234228 can be used. The detailed explanations of these methods can be referred in the above publications JPA 10-326278 and JPA 2004-234228.

The feature quantity obtaining section 37 obtains one feature quantity of the extracted area. To obtain the feature quantity, the method disclosed in Japanese Patent Application Laid-open Publications No 08-221547 using mosaic classification, the method disclosed in Japanese Patent Application Laid-open Publications No 2003-178304 for using histogram based on the part extracted from the area as the feature quantity, and the like can be used. The detailed explanations of these methods can be referred in the above publications JPA 8-221547 and JPA 2003-178304.

The keyword extractor 38 analyzes the text data that is input to the server 11 with the image, and extracts plural of the keywords belonging to the category to which the area extracted by the area extractor 36 belongs. Specifically, in extracting the keywords of the category related to “human”, when the text data are nouns representing names of persons like “Kayla” and “Alyssa”, the keyword extractor 38 extracts the text data themselves as the keywords. When the text data are sentences like “Popular idols Kayla and Alyssa release their first collaboration photo book. Shooting is well under way by the photographer Michael.”, the keyword extractor 38 performs syntactic analysis for analyzing grammatical structure of the sentences to the text data. Based on the analysis results, the keyword extractor 38 extracts the keywords from the text data. In this case, “Kayla”, “Alyssa” and “Michael” are extracted. When names of persons are extracted using morphological analysis, time for the processing may be shortened. See Japanese Patent Application Laid-open Publication No. 2003-228569 for the specific method of the morphological analysis. The keywords may be extracted using other methods aside the method using the morphological analysis.

The keyword selecting section 39 selects one keyword as metadata from among the plural keywords extracted by the keyword extractor 38 based on the obtained image feature quantity. Specifically, the keyword selecting section 39 refers to the list table of feature quantity and the list table of word of the category to which the area extracted by the area extractor 36 belongs, and thereby selecting one keyword corresponding to the feature quantity obtained by the feature quantity obtaining section 37 from among the plural keywords extracted by the keyword extractor 38.

For example, in the case where the face areas 51 and 52 (see FIG. 8) are extracted by the area extractor 36, the category is judged as “human”, and “Kayla”, “Alyssa” and “Michael” are extracted by the keyword extractor 38, the keyword selecting section 39 refers to the list table 49 of human feature quantity (see FIG. 7) and the list table 44 of person name (see FIG. 4), and judges as to which image feature quantity the face areas 51 and 52 are respectively most similar to among the image feature quantity of word ID “0001” related to “Kayla”, the image feature quantity of word ID “0002” related to “Alyssa” and the image feature quantity of word ID “0003” related to “Michael”. The person's name related to the word ID of the judged image feature quantity is selected as the keyword corresponding to the image feature quantity.

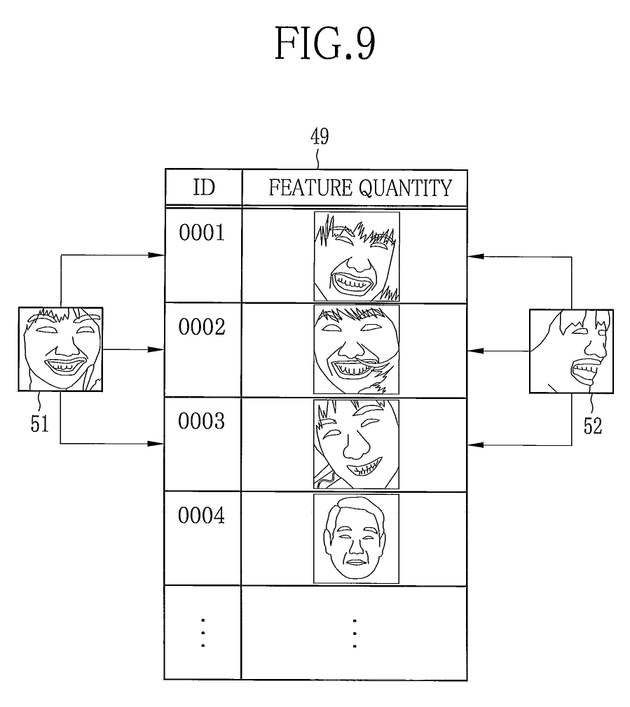

When the feature quantity of the face area 51 is judged as most similar to the image feature quantity of the word ID “0002” as shown in FIG. 9, the keyword selecting section 39 selects “Alyssa” for the word ID “0002” (see FIG. 4) as the keyword corresponding to the face area 51. Similarly, when the feature quantity of the face area 52 is judged as most similar to the image feature quantity of the word ID “0001”, the keyword selecting section 39 selects “Kayla” for the word ID “0001” (see FIG. 4) as the keyword corresponding to the face area 52.

The metadata assigning section 40 assigns the keyword selected by the keyword selecting section 39 to the image as the metadata. At this time, the keyword is assigned in relation with the area extracted by the area extractor 36. For example, in the case where the face areas 51 and 52 are extracted from the image 50 (see FIG. 8), and “Alyssa” is selected as the keyword corresponding to the face area 51 while “Kayla” is selected as the keyword corresponding to the face area 52, the metadata assigning section 40 assigns the keywords “Kayla” and “Alyssa” to the image 50 as the metadata while relating the keyword “Alyssa” to the face area 51 and the keyword “Kayla” to the face area 52. The metadata are recorded in a tag and the like of an image file storing one image. It is also possible that a file relating the image and the metadata is produced.

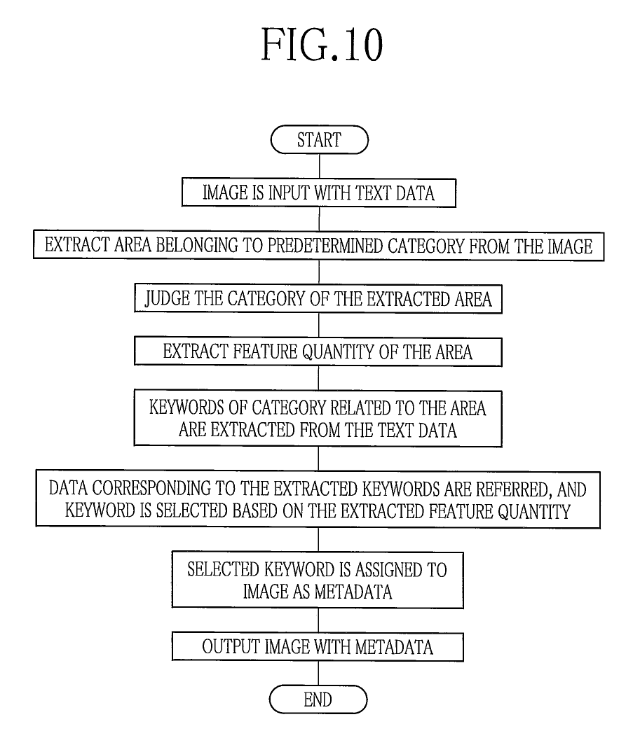

Now the processing procedures for assigning the metadata will be described with reference to the flow chart shown in FIG. 10. A user operates the operation section 18 of the client terminal 13 and inputs an image with text data to the server 11. The text data and the image input to the server 11 are stored in the RAM 33.

The image stored in the server 11 is read out from the RAM 33 to the area extractor 36. The area extractor 36 analyzes the image. The area extractor 36 then extracts at least one area belonging to one of the categories registered in the list table of feature quantity stored in the feature quantity DB 43 and also judges the category to which the extracted area belongs. The extracted area is stored in the RAM 33 with the category judgment results.

The area extracted by the area extractor 36 is read out from the RAM 33 to the feature quantity obtaining section 37. The feature quantity obtaining section 37 obtains the feature quantity of the area extracted by the area extractor 36. The obtained feature quantity is stored in the RAM 33.

Meanwhile the text data input to the server 11 is read out from the RAM 33 to the keyword extractor 38 with the category judgment results obtained by the area extractor 36. The keyword extractor 38 analyzes the text data and extracts plural keywords of the judged category related to the extracted area. The extracted plural keywords are stored in the RAM 33.

The area extracted by the area extractor 36, the feature quantity obtained by the feature quantity obtaining section 37, the plural keywords extracted by the keyword extracting section 38 are read out from the RAM 33 to the keyword selecting section 39. The keyword selecting section 39 accesses the text DB 42 and the feature quantity DB 43 and retrieves plural image feature quantities based on the plural keywords extracted by the keyword extractor 38. Among the plural image feature quantities, one feature quantity most similar to the feature quantity obtained by the feature quantity obtaining section 37 is selected. Then, one keyword corresponding to the selected image feature quantity is selected. The selected keyword is stored in the RAM 33.

The keyword selected by the keyword selecting section 39 is read out from the RAM 33 to the metadata assigning section 40. The metadata assigning section 40 assigns the keyword to the image as the metadata. The image with the metadata assigned is stored in the RAM 33.

The image with the assigned metadata is read out from the RAM 33 and sent to the server 11 via the communication I/F 35. The image output from the sever 11 is sent to the client terminal 13.

As explained above, the keywords are extracted from the text data after narrowing down the categories only to those related to the feature quantity of the image, the processing time for selecting the keyword to be the metadata from among the extracted keywords can be shortened, and also high quality keyword can be selected.

When the keyword selecting section 39 selects the keyword based on the feature quantity of the extracted area by accessing the feature quantity DB 43 storing the keywords and the image feature quantities in relation with each other one by one, limited number of image feature quantities stored in the feature quantity DB are referred. Owing to this, the processing time for selecting the keyword can be shortened.

In the above embodiment, the area extractor 36 extracts areas related to various categories (human, cars, citrus fruits, etc.). Alternatively, the area extractor 36 may be limited to extract only the face areas related to human face. In this case, the keyword selecting section 39 selects only the keywords related to names of persons as the metadata assigned to the image, based on the feature quantity of the face area extracted by the area extractor 36. The specified category is not limited to “human” but may be “car”, “citrus fruit” or any other category.

In the above embodiment, although the server 11 connected to the internet 12 works as the metadata assigning device, a personal computer for individual use, for example, may be used as the metadata assigning device.

The metadata assigning device described in the above embodiment is merely an example of the present invention. Various changes and modifications are possible in the present invention and may be understood to be within the present invention.

What is claimed is:

1. A metadata assigning device for assigning metadata to an image based on text data which is input with said image, comprising:
an area extractor for extracting at least one area belonging to a predetermined category from said image;
a keyword extractor for extracting plural keywords belonging to said category from said text data;
a feature quantity obtaining section for obtaining one feature quantity for said extracted area; and
a keyword selecting section for referring to a list table of feature quantity in which image feature quantities and keywords in said category are related to each other one by one and retrieving plural of said image feature quantities based on said extracted plural keywords, said keyword selecting section selecting one of said retrieved image feature quantities which is most similar to said obtained feature quantity, said keyword selecting section obtaining said keyword related to said selected image feature quantity on said list table of feature quantity and selecting said obtained keyword as said metadata.

2. The metadata assigning device of claim 1, wherein said area is a human face area and said keywords are names of persons.

3. A metadata assigning method for assigning metadata to an image based on text data which is input with said image, comprising the steps of:
extracting at least one area belonging to a predetermined category from said image;
extracting plural keywords belonging to said category from said text data;
obtaining one feature quantity for said extracted area;
referring to a list table of feature quantity in which image feature quantities and keywords in said category are related to each other one by one and retrieving plural of said image feature quantities based on said extracted plural keywords;
selecting one of said retrieved image feature quantities which is most similar to said obtained feature quantity; and
obtaining said keyword related to said selected image feature quantity on said list table of feature quantity and selecting said obtained keyword as said metadata.

4. The metadata assigning device of claim 3, wherein said area is a human face area and said keywords are names of persons.

5. A computer executable metadata assigning program for assigning metadata to an image based on text data which is input with said image, comprising the steps of:
extracting at least one area belonging to a predetermined category from said image;
extracting plural keywords belonging to said category from said text data;
obtaining one feature quantity for said extracted area;
referring to a list table of feature quantity in which image feature quantities and keywords in said category are related to each other one by one and retrieving plural of said image feature quantities based on said extracted plural keywords;
selecting one of said retrieved image feature quantities which is most similar to said obtained feature quantity; and
obtaining said keyword related to said selected image feature quantity on said list table of feature quantity and selecting said obtained keyword as said metadata.

6. The metadata assigning program of claim 5, wherein said area is a human face area and said keywords are names of persons.
